(19) United States
(12) Patent Application Publication
(10) Pub. No.: US 2016/0038879 A1
(43) Pub. Date: Feb. 11, 2016

(54) MEMBRANE DISTILLATION MODULE AND WASTEWATER TREATMENT APPARATUS

(71) Applicant: SUMITOMO ELECTRIC INDUSTRIES, LTD., Osaka (JP)

(72) Inventors: Atsushi YAMAGUCHI, Osaka (JP); Toru MORITA, Osaka (JP)

(73) Assignee: Sumitomo Electric Industries, Ltd., Osaka-shi, Osaka (JP)

(21) Appl. No.: 14/782,614

(22) PCT Filed: Nov. 26, 2014
(86) PCT No.: PCT/JP2014/081169

§ 371 Date: Oct. 6, 2015

(30) Foreign Application Priority Data
Nov. 27, 2013 (JP) 2013-245495

(51) Int. Cl. B01D 61/36; B01D 63/02; C02F 1/44; B01D 71/34; B01D 71/36; B01D 71/32; B01D 63/06

(52) U.S. Cl. CPC B01D 61/364; B01D 71/32; B01D 63/02; B01D 63/06; B01D 71/34; B01D 71/36; C02F 1/447; B01D 61/366; C02F 2101/006

(57) ABSTRACT

A membrane distillation module and a wastewater treatment apparatus are provided which performs purification through membrane distillation using a porous membrane provided with an oil-repellent layer obtained by combining and immobilizing a substance having an oil-repellent function on at least one surface of a base membrane implemented by a hydrophobic porous membrane.

### TECHNICAL FIELD

The present invention relates to a membrane distillation module and a wastewater treatment apparatus, which are particularly used suitably for purifying high-temperature oil-containing wastewater or a radioactive substance-contaminated water.

### BACKGROUND ART

Oil-containing wastewater called produced water or flowback wastewater obtained from an oil field, a gas field or the like is highly-contaminated wastewater containing many underground ions and salt components, having part of exploited oil remaining therein, and further containing many underground solid materials. Therefore, the wastewater needs to be purified both in the case of recycling for reuse and in the case of disposal.

With a typical purification process, gravity separation is performed first, and then an oil component remaining in the water is removed by coagulation sedimentation, sand filtration, a hydrocyclone, dissolved air floatation, or the like. Furthermore, in order to remove a salt component, purification is performed using an ion exchange resin, a reverse osmotic membrane, an evaporator, or the like is used. Since many steps are required in this way, initial cost and maintenance cost increase.

Meanwhile, development of an adsorbent and the like for adsorbing numerous radioactive nuclides are being developed for radioactive wastewater and the like having raised an issue these days. There are many problems, such as change in performance due to interfering substances, and performance degradation due to clogging or the like of adsorption sites with an oil component and the like contained in radioactive wastewater.

A method by which a multi-stage step in treating oil-field produced water or the like can be carried out by one stage, and radioactive substances can also be purified includes a membrane distillation process using a hydrophobic porous membrane that does not allow water to permeate therethrough but allows steam to permeate therethrough. The applicant of the present application provides desalination apparatus using this membrane distillation process in Japanese Patent Laying-Open No. 2013-34928 (PTD 1).

### CITATION LIST

### Patent Document

### PTD 1: Japanese Patent Laying-Open No. 2013-34928

### SUMMARY OF INVENTION

### Technical Problem

As provided in PTD 1, in the case of purifying and desalinating raw water including sea water, domestic wastewater, well water, and the like as raw water through membrane distillation, the membrane distillation process is used suitably, but the membrane distillation process is considered unsuitable for treating oil-containing wastewater containing a large amount of oil component.

This is because in the case of oil-containing wastewater containing a large amount of oil component, the oil component is likely to adhere to the surface of a porous membrane, and is not easily dropped off with membrane shaking by means of air diffusion after adhesion, so that the surface of the porous membrane is covered with the oil component, resulting in degraded water repellency and increased wettability. As a result, water enters holes of the porous membrane to form a water retained layer, and steam cannot permeate therethrough. Therefore, purification by means of membrane distillation cannot be achieved.

The present invention was made in view of the above-described problems, and has an object to maintain treatment capability for a long period and to reduce maintenance frequency even when adopting membrane distillation for purifying oil-containing wastewater containing a large amount of oil component and further, radioactive substance-contaminated wastewater.

### Solution to Problem

In order to achieve the object, the present invention provides a membrane distillation module, including a porous membrane having an oil-repellent layer obtained by combining and immobilizing a substance having an oil-repellent function on at least one surface of a base membrane implemented by a heat-resistant hydrophobic porous membrane made of a water-repellent fluororesin of PTFE (polytetrafluoroethylene), PVDF (polyvinylidene difluoride) or PCTFE (polychlorotrifluoroethylene) and having a practical maximum operating temperature exceeding 80° C.

As described above, since the porous membrane has the oil-repellent layer provided on the surface of the hydrophobic porous membrane, an oil component contained in wastewater can be reduced/prevented from adhering to the surface of the porous membrane. Thus, maintenance frequency for the porous membrane can be reduced to reduce running cost, and productivity can be improved. In particular, since water containing an oil component is not allowed to permeate through the porous membrane, the holes of the porous membrane are not blocked with the oil component or foreign matters. Thus, regardless of the content of the oil component contained in wastewater and the size of solid materials, such as foreign matters, wastewater can be purified by membrane distillation even if it has high turbidity, which can eliminate the need for multi-stage pretreatment required in the case of microfiltration.

The oil-repellent function means that, for example, when a hollow fiber membrane is immersed into 100% n-hexane for impregnation, oil does not enter holes in the membrane surface by visual observation, that is, the membrane is not moistened. By another index, it means that the rate of change of ventilation performance of the membrane does not substantially vary.

A method that can be adopted as a method for providing the oil-repellent layer on the surface of the hydrophobic porous membrane is to impregnate a porous membrane with a solution by a technique of preparing the solution in which a fluorination monomer or further a polymerization initiator has been dissolved, and immersing a porous membrane in that solution, or a technique of forming a module by a porous membrane, and then injecting this solution into the porous material, and then to remove the solvent by volatilization. In implementation, by dissolving a monomer and then diluting it with a solvent to set the concentration properly, a proper amount can be held without a porous portion being clogged. On the other hand, at least one of the surfaces of the hydrophobic porous membrane is impregnated with a solvent containing a proper concentration of a substance having already become a polymer dissolved therein or the solvent is applied to the one surface, and then dried, or the above-mentioned substance is deposited with a poor solvent. The oil-repellent layer can also be obtained by carrying out this step after forming a membrane module.

Preferably, the substance exhibiting the oil-repellent function is at least one type of high polymer selected from polymers having a fluorinated alkyl side chain.

The hydrophobic porous membrane provided with the oil-repellent layer on the surface to exhibit the oil-repellent function is implemented by a porous membrane used for membrane distillation which does not allow fluid such as water to permeate therethrough, but allows steam to permeate therethrough. Specifically, the porous membrane has an average hole diameter of 0.01 μm to 1 μm, with the oil-repellent layer having such a porosity that does not block the micropores of the hydrophobic porous membrane, and can be used for membrane distillation.

The porous membrane for membrane distillation of the present invention has a porosity of 50% to 90%, preferably 65% to 85%, and more desirably 70 to 80%, and preferably has a thickness of 10 μm to 5 mm. Particularly, as the porosity of the hydrophobic porous membrane is higher, a fluorination monomer or a polymer is allowed to uniformly permeate into each hole in the oil-repellent treatment.

As described above, the base membrane made of a hydrophobic porous membrane is implemented by a hydrophobic porous membrane made of fluorine-based resin including PTFE (polytetrafluoroethylene), PVDF (polyvinylidene difluoride) and PCTFE (polychlorotrifluoroethylene), having a practical maximum operating temperature exceeding 100° C., and having alkali resistance. That is, in order to allow steam to permeate through the porous membrane with oil-containing wastewater to be treated at a high temperature at which steam is produced, the porous membrane needs to have heat resistance. Furthermore, the PTFE, PVDF and PCTFE have high water contact angle, and are excellent in hydrophobicity. Therefore, even if there are partial deterioration and detachment of a substance which exhibits the oil-repellent function on the surface, poor wettability against water or oil prevents water from entering the holes of the porous membrane, so that membrane distillation can be continued.

Moreover, the PTFE, PVDF and PCTFE have chemical resistance. In order to remove an oil component adhering to the surface of the porous membrane, the oil component needs to be remove by dissolution by chemical cleaning with an alkaline aqueous solution or an oxidizing agent solution, so that the wastewater is reproduced repeatedly. The membrane has durability because of its alkali resistance and oxidation resistance, and can maintain treatment performance for a long period of time.

Preferably, among others, the base membrane made of the hydrophobic porous membrane is an expanded PTFE porous membrane, and a high polymer having a perfluoroalkyl group of a substance having the oil-repellent function in a side chain is held in at least one of surfaces of the base membrane.

Among the PTFE, PVDF or PCTFE, an expanded PTFE porous membrane is used particularly suitably because of its mechanical strength, chemical resistance, sufficient porosity for holding an oil-repellent polymer, ease of manufacturing, and the like.

The porous membrane used for membrane distillation of the present invention preferably has a form of (1) a hollow fiber membrane, (2) a tubular porous membrane obtained by winding a porous sheet and securing wound ends by sealing to represent a cylindrical shape, or (3) a bag-like composite membrane obtained by sealing, such as by heat sealing, both ends of porous membranes laminated on both surfaces of a dissimilar material, such as a nonwoven fabric, a flow path material, such as a net, being included on the inner side of the composite membrane.

Preferably, in the hollow fiber membrane (1), the tubular porous membrane (2), or the composite membrane (3), the oil-repellent layer serves as the outer surface where wastewater containing an oil component or a gas component flows, and the hollow portion serves as a treated liquid flow path.

As described above, when the hollow fiber membrane (1), the tubular porous membrane (2) or the composite membrane (3) serves as the treated liquid flow path, treated liquid flows favorably. Thus, a deflection is unlikely to occur, and the temperature difference is made uniform, so that membrane distillation capability can be stabilized ensuring the temperature difference stably.

Preferably, a circulative path for the high-temperature wastewater is provided on the outer peripheral surface where the oil-repellent layer is provided, and a hollow portion surrounded by the inner peripheral surface serves as a circulative path for the cooling water.

Particularly, the expanded PTFE porous membrane is used most suitably because of its excellent heat resistance, strength and cleaning chemical resistance. Preferably, the expanded PTFE porous membrane is used in the above-described forms of (1) to (3).

The expanded PTFE membrane itself in each of the above-described forms is set to have an average hole diameter of 0.01 μm to 1 μm. The porosity is more than or equal to 50%, preferably 50% to 90%, more preferably 65% to 85%, and still more preferably 70 to 80%. The reason for setting the porosity as described above is as follows: a membrane having a higher porosity is desirable in terms of steam permeability because the diffusion resistance is lower, and the speed is faster. As to holding of an oil repellent agent, higher porosity results in a larger specific surface area, and hence a larger holding force, by which stable holding is easier to achieve.

When the hollow fiber membrane (1) is adopted, it is preferable to set the inner diameter at 0.5 mm to 1.0 mm. When the tubular porous membrane (2) is adopted, it is preferable to set the inner diameter at 3 mm to 20 mm.

Preferably, the hollow fiber membrane (1) has a thickness of 0.3 to 1 mm, the tubular porous membrane (2) has a thickness of 30 μm to 1 mm, and the composite membrane (3) has a thickness of 10 μm to 5 mm.

As described above, the hollow fiber membrane (1), the tubular porous membrane (2) or the composite membrane (3) made of the expanded PTFE porous material desirably has a high strength. It is preferable that a tensile strength at 25° C. be more than or equal to 30N, preferably more than or equal to 50N, and the upper limit is about 150N.

The tensile strength was in conformity with JIS K 7161, and the hollow fiber membrane itself was used as a test piece. Measurement was performed setting the pulling rate during the test at 100 mm/min and the gauge length at 50 mm. Accordingly, when the tensile strength is set at more than or equal to 30N, a highly reliable operation is also possible in membrane distillation always operated at high temperature, over a long period of time without leakage that would be caused by membrane cracking and the like.

Because of the chemical resistance, even if a high-concentration alkali cleaning solution or an oxidation-resistant cleaning solution is repeatedly used, the membrane will not degrade in treatment capacity and strength, and a high-performance purifying function can be maintained over a long period of time.

Wastewater from which only steam is allowed to permeate through the porous membrane shall contain more than or equal to 200 mg/l, preferably more than or equal to 500 mg/l and less than or equal to 10,000 mg/l of an oil component, more than or equal to 50,000 mg/l of a low-molecular organic matter being nonvolatile at an operating temperature or below and being water-soluble, or more than or equal to 50,000 mg/l of a soluble salt component.

Wastewater from which only steam is allowed to permeate through the porous membrane contains an oil component or a radioactive substance and an oil component.

Among others, the high-temperature oil-containing wastewater is suitably used for treating high-temperature oil-containing wastewater separated from bitumen extracted from a heated bitumen-mixed fluid recovered from oil sands by the SAGD process or the CSS process and having a temperature of 60 to 150° C.

That is, adopting the membrane distillation module of the present invention, the equipment and process for producing bitumen by the in-situ recovery method (the SAGD process or the CSS process) from oil sands can be reduced significantly, and environmental problems can also be reduced significantly. Particularly, since it is necessary to heat wastewater to produce steam in the membrane distillation process, large-capacity equipment and a heat source are required, which disadvantageously increases initial cost and maintenance cost. Since the high-temperature oil-containing wastewater produced in the step of extracting bitumen from oil sands has a high temperature at which steam is produced without being heated, running cost can be reduced significantly. According to the in-situ recovery method, high-temperature steam is injected into high-viscosity oil in an oil sand layer, in which the oil does not flow at a normal temperature, to reduce the viscosity of oil by heating, thereby recovering high-temperature water and oil. In order to produce a large amount of high-temperature steam, water of about three times or more as much as the amount of oil produced. However, the amount of water intake is limited. Therefore, recycling of water is indispensable. When the purified water having been subjected to the membrane distillation is recycled as water for producing this high-temperature steam, it can be utilized very efficiently.

Furthermore, the oil-containing wastewater is wastewater containing a large amount of salt component and solid matter, that is, it is also suitably used for purifying sea water in which oil floats, or the like.

The present invention further provides a wastewater treatment apparatus including the above-described membrane distillation module.

Preferably, in the wastewater treatment apparatus, a wastewater circulative pipe is coupled to the wastewater circulation side of the membrane distillation module, and a wastewater tank, a circulative pump and a heater are inserted in the wastewater circulative pipe, while a cooling water circulative pipe is coupled to the treated fluid side of the membrane distillation module, and a cooling water tank, a circulative pump, and a cooler are inserted in the cooling water circulative pipe.

The treated water having been subjected to the membrane distillation hardly contains an oil component, an organic matter containing naphthenic acid and a salt component, or inorganic radioactive substances, such as or strontium or cesium. It is expectable that the quality of treated water, namely, the increment relative to “an analysis value of aqueous concentration of each substance in circulating cooling water in the treatment initiation stage” becomes at least less than 1 mg/l, further less than 0.1 mg/l, or less than or equal to a detection limit. Since the salt component can also be removed together with the oil component as described above, the treated water having been subjected to membrane distillation can have high purity, and various types of reuse and discharge can be implemented.

### Advantageous Effects of Invention

As described above, adopting the membrane distillation module of the present invention using the porous membrane with the oil-repellent layer having the oil-repellent function provided on the surface of the heat-resistant hydrophobic porous membrane, an oil component contained in wastewater can be reduced/prevented from adhering to the surface of the porous membrane. Thus, maintenance frequency for the porous membrane can be reduced to reduce running cost, and productivity can be improved. In particular, since water containing an oil component is not allowed to permeate through the porous membrane, the holes of the porous membrane are not blocked by the oil component or foreign matters. Therefore, regardless of the content of oil component contained in wastewater, the size of solid materials, such as foreign matters, purification can be achieved by membrane distillation even if turbidity is high, and the need for multi-stage pretreatment required in the case of microfiltration, adsorption treatment and the like can be eliminated.

### BRIEF DESCRIPTION OF DRAWINGS

FIG. 1 shows a membrane distillation module of a first embodiment, a vertical sectional view shown at (A), an enlarged perspective view of a hollow fiber membrane shown at (B), and a partial enlarged cross sectional view of an assembled bundle of hollow fiber membranes shown at (C).

FIG. 2 is an overall block diagram of a wastewater treatment apparatus including the membrane distillation module.

FIG. 3 is an overall block diagram showing a variation of the wastewater treatment apparatus.

FIG. 4 is a perspective view showing a second embodiment and showing a tubular porous membrane used for a membrane distillation module.

FIG. 5 shows a third embodiment, a conventional block diagram shown at (A), and a block diagram of the present invention shown at (B).

### DESCRIPTION OF EMBODIMENTS

Hereinafter, embodiments of the present invention will be described with reference to the drawings.

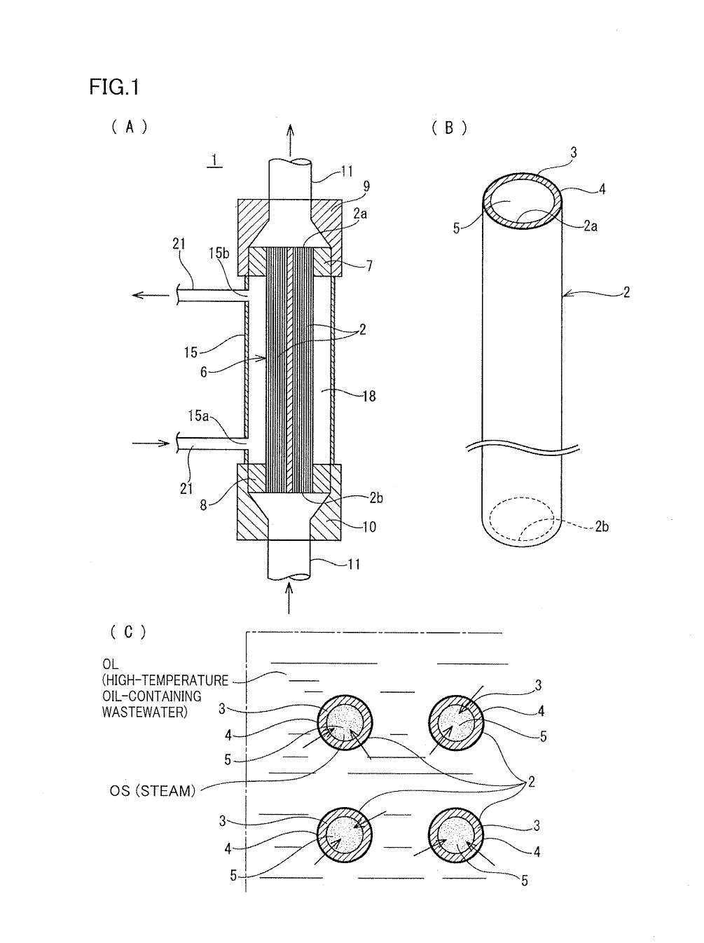

FIG. 1 shows a membrane distillation module of a first embodiment of the present invention.

A membrane distillation module 1 of the embodiment purifies high-temperature oil-containing wastewater through membrane distillation.

Membrane distillation module 1 adopts a hollow fiber membrane 2 shown in FIG. 1 at (B) as a porous membrane for membrane distillation.

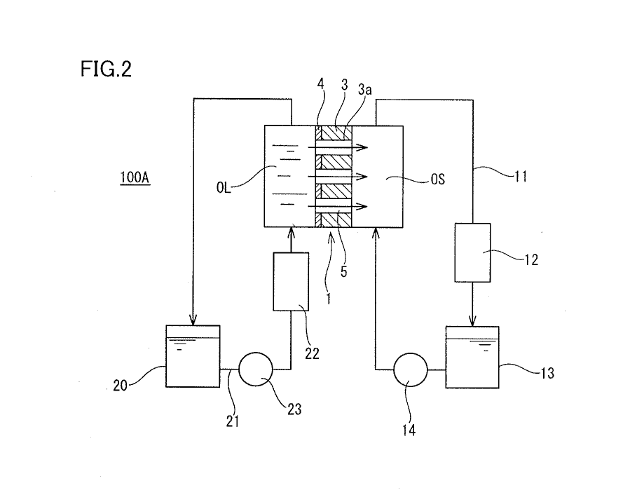

In hollow fiber membrane 2, a base membrane 3 is implemented by an expanded PTFE porous membrane, and an oil-repellent layer 4 held by impregnating the expanded PTFE porous membrane with a solution containing polymer having a fluorinated alkyl side chain having the oil-repellent function in such a mode that holes 3a (shown in FIG. 2) of base membrane 3 are not closed is provided on the outer peripheral surface of porous membrane 3.

The oil-repellent polymer used for oil-repellent layer 4 only needs to be a substance having the oil-repellent function, and is not limited to the polymer having the fluorinated alkyl side chain.

Hollow fiber membrane 2 described above having oil-repellent layer 4 provided on the outer peripheral surface of base membrane 3 is implemented by a porous membrane for membrane distillation whose average hole diameter is set such that water is not allowed to permeate therethrough but only steam is allowed to permeate therethrough. The average hole diameter is in the range of 0.01 μm to 1 μm.

As shown in FIG. 1 at (C) and FIG. 2, hollow fiber membrane 2 is in contact with high-temperature oil-containing wastewater OL by the outer peripheral surface on which oil-repellent layer 4 is provided, and the hollow portion serves as a treated liquid flow path 5 for treated liquid permeated through the hollow portion.

Base membrane 3 to serve as treated liquid flow path 5 has an inner diameter of 0.5 mm to 4 mm, a thickness of 10 μm to 5 mm, a porosity of 40 to 90%, and a tensile strength of 30 to 150N.

As shown in FIG. 1 at (A) and (C), membrane distillation module 1 has an assembled bundle 6 in which a plurality of hollow fiber membranes 2 are arranged at required intervals (0.5 mm to 20 mm). The upper and lower both ends of this assembled bundle 6 are fixed by upper and lower fixing plates 7 and 8 with upper and lower openings 2a and 2b of each hollow fiber membrane 2 being open. Caps 9 and 10 are fitted over upper and lower fixing plates 7 and 8, respectively, and the both ends of a circulative cooling pipe 11 are connected to caps 9 and 10.

An outer casing 15 for coupling upper and lower fixing plates 7 and 8 is attached to surround assembled bundle 6 leaving space which serves as high-temperature oil-containing wastewater circulation space 18. An inlet 15a and an outlet 15b continuing with a wastewater circulative pipe 21 are provided on the upper and lower sides of this outer casing 15.

As shown in FIG. 2, wastewater treatment apparatus 100A including membrane distillation module 1 has a cooler 12, a cooling water tank 13 and a circulative pump 14 inserted in circulative cooling pipe 11 of membrane distillation module 1. Circulative cooling pipe 11 is arranged in the atmosphere to serve as a cooling pipe for cooling high-temperature treated liquid.

A wastewater reservoir 20, a circulative pump 23 and a heater 22 are inserted in wastewater circulative pipe 21 for circulating high-temperature oil-containing wastewater OL.

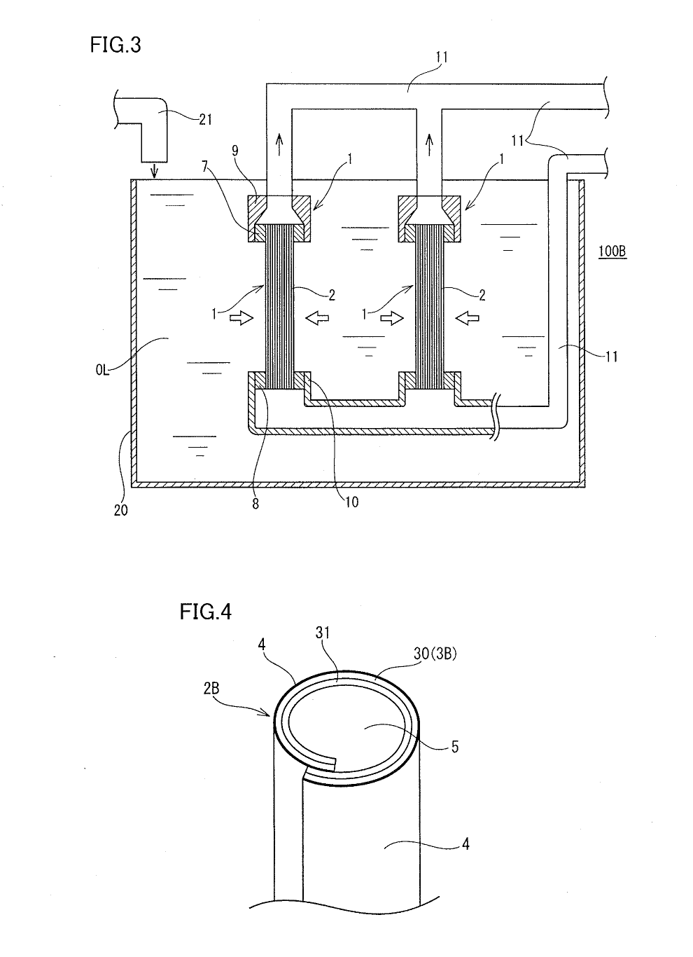

In a wastewater purification apparatus 100B of the variation shown in FIG. 3, a plurality of membrane distillation modules 1 are arranged in wastewater reservoir 20.

In both of wastewater purification apparatus 100A shown in FIG. 2 and wastewater purification apparatus 100B shown in FIG. 3, upper and lower fixing plates 7, 8, upper and lower caps 9, 10, and further, an outer casing 25 are made of heat-resistant resin or a metal material, and the module is superior in alkali resistance as a whole.

Although not shown in wastewater treatment apparatuses 100A and 100B, a cleaning device for cleaning membrane module 1 with a cleaning solution of an alkaline aqueous solution is additionally provided.

Next, the functions of the wastewater treatment apparatus including membrane distillation module 1 will be described.

Since the functions of membrane distillation in wastewater treatment apparatuses 100A and 100B are identical, description will be made based on wastewater treatment apparatus 100A of FIG. 2.

As to high-temperature oil-containing wastewater OL producing steam continuously supplied to membrane distillation module 1, only steam permeates through hollow fiber membrane 2 made of a porous membrane, and steam OS flows into treated liquid flow path 5 in the hollow portion. Steam OS flown into this treated liquid flow path 5 rises up to flow into circulative cooling pipe 11 provided continuously at the top. Since circulative cooling pipe 11 is located in the atmosphere, it has a temperature of 20° C. to 40° C., and steam is rapidly cooled within this circulative cooling pipe 11, and further, cooled to be liquefied by cooler 12 installed downstream according to necessity, and stored in cooling water tank 13. The cooling water in this cooling water tank 13 is taken out and utilized for reuse. It is preferable to take out part of the cooling water by a circulative pump 14, and send it to annular cooling pipe 11 to flow into treated liquid flow path 5 in the hollow of hollow fiber membrane 2, to bring it into contact with steam permeating through hollow fiber membrane 2 and to cool it rapidly.

Since hollow fiber membrane 2 of membrane distillation module 1 has oil-repellent layer 4 disposed on the outer peripheral surface to be in contact with high-temperature oil-containing wastewater OL, an oil component is unlikely to adhere, which can reduce/prevent any adhering oil to block the holes of the hollow fiber membrane. Thus, reduction in membrane distillation capability can be restrained/prevented.

In high-temperature oil-containing wastewater OL to be purified by membrane distillation module 1, a non-water soluble oil component content containing more than or equal to 200 mg/I of oil component can be set at less than ling/1.

High-temperature oil-containing wastewater OL to be purified by membrane distillation module 1 is used particularly suitably when it has a high temperature at which steam is produced. If steam is not produced, high-temperature oil-containing wastewater OL is heated to a temperature at which steam is produce by heater 22 inserted in wastewater circulative pipe 21, and then supplied to membrane distillation module 1.

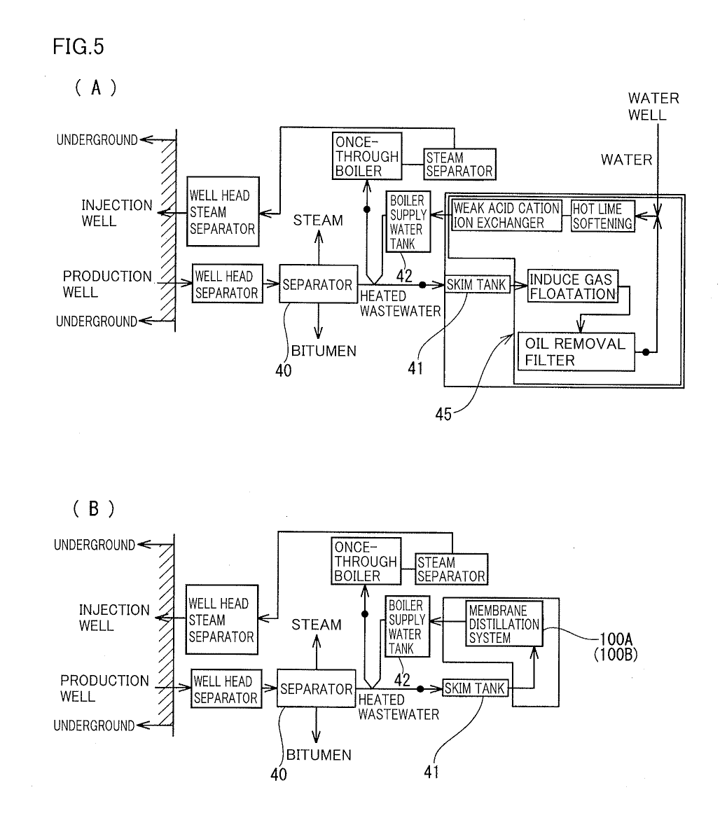

A membrane distillation module of a second embodiment is shown in FIG. 4.

In a hydrophobic porous membrane 2B used in the membrane distillation module, a PTFE porous sheet 30 is wound and wound ends are secured by sealing to represent a cylindrical shape to obtain a tubular porous membrane serving as a base membrane 3B, instead of using a hollow fiber membrane made of a PTFE porous material as a base membrane. Oil-repellent layer 4 is provided on the outer peripheral surface of this base membrane 3B similarly to the first embodiment, while a support layer 31 is provided on the inner peripheral surface by laminating nonwoven fabrics. When adopting the tubular porous membrane as base membrane 3B, the hollow portion to serve as treated liquid flow path 5 can have a cross-sectional area larger than in the first embodiment.

Since other structure and functions are similar to those of the first embodiment, description thereof is omitted.

FIG. 5 shows a third embodiment.

In the third embodiment, a wastewater apparatus including membrane distillation module 1 is used in the step of recovering bitumen from oil sands by the in-situ recovery method as disclosed in Japanese Patent Laying-Open No. 2010-248431 related to a prior application filed by the applicant of the present application.

FIG. 5 (A) is a flowchart for reuse treatment of oil-containing water by the flow of the conventional SAGD process shown in FIG. 7 of Japanese Patent Laying-Open No. 2010-248431. As shown in this flowchart, heated oil-containing salt-containing wastewater to be supplied from a separator 40 through a skim tank 41 is purified by a purification device 45 shown as enclosed by a frame, and then supplied to a boiler supply tank 42. In purification device 45, a multi-stage step of processing induce gas floatation, an oil removal filter, hot lime softening, and a weak acid cation ion exchanger is required.

On the other hand, in the third embodiment of the present invention, purification device 45 is replaced by wastewater treatment apparatus 100A (or 100B) in which one-step membrane distillation is utilized, as shown in FIG. 5 at (B).

That is, a high-temperature oil-containing salt-containing wastewater is supplied to wastewater treatment apparatus 100A from separator 40 where gravity separation is performed through skim tank 41. The high-temperature oil-containing salt-containing wastewater is supplied to the outer surface side on which oil-repellent layer 4 of porous membrane 2 of membrane distillation module 1 is provided to reproduce high-temperature water from the steam permeated through porous membrane 2, and this purified high-temperature water is supplied to boiler supply tank 42.

In this way, in contrast to the conventional apparatus shown in FIG. 5 at (A), the apparatus of the present invention shown in FIG. 5 at (B) can perform the multi-stage wastewater purification step in one-stage step, which can significantly reduce equipment cost and running cost.

### REFERENCE SIGNS LIST

1 membrane distillation module; 2 hollow fiber membrane; 3 base membrane; 4 oil-repellent layer; 5 treated liquid flow path; 6 assembled bundle; OL oil-containing wastewater; OS treated liquid.

1. A membrane distillation module, comprising a porous membrane having an oil-repellent layer obtained by combining and immobilizing a substance having an oil-repellent function on at least one surface of a base membrane implemented by a heat-resistant hydrophobic porous membrane made of a water-repellent fluororesin of one of PTFE (polytetrafluoroethylene), PVDF (polyvinylidene difluoride) and PCTFE (polychlorotrifluoroethylene) and having a practical maximum operating temperature exceeding 80° C.

2. The membrane distillation module according to claim 1, wherein the hydrophobic porous membrane serving as said base membrane has a porosity of more than or equal to 50%.

3. The membrane distillation module according to claim 1, wherein said substance having the oil-repellent function is at least one type of high polymer selected from polymers having a fluorinated alkyl side chain.

4. The membrane distillation module according to claim 1, wherein said hydrophobic porous membrane is implemented by one of (1) a hollow fiber membrane, (2) a tubular porous membrane obtained by winding a porous sheet and securing wound ends by sealing to represent a cylindrical shape, and (3) a bag-like composite membrane obtained by sealing, by heat sealing, both ends of a single porous sheet or two porous membranes laminated on both surfaces of a dissimilar material which is a nonwoven fabric, and provided with slits of a specified width, a flow path material which is a net being included on the inner side of said composite membrane.

5. The membrane distillation module according to claim 1, wherein a circulative path for the heated wastewater is provided on an outer peripheral surface where said oil-repellent layer is provided, and a hollow portion surrounded by an inner peripheral surface serves as a circulative path for cooling water.

6. The membrane distillation module according to claim 1, wherein wastewater from which only steam is allowed to permeate through said porous membrane contains one of more than or equal to 200 mg/l of an oil component, more than or equal to 50,000 mg/l of a low-molecular organic matter being nonvolatile at an operating temperature or below and being water-soluble, and more than or equal to 50,000 mg/l of a soluble salt component.

7. The membrane distillation module according to claim 1, wherein wastewater from which only steam is allowed to permeate through said porous membrane contains a radioactive substance and an oil component.

8. The membrane distillation module according to claim 6, wherein said wastewater is high-temperature oil-containing wastewater after separating bitumen from a heated bitumen-mixed fluid recovered from oil sands by the SAGD process or the CSS process.

9. A wastewater treatment apparatus comprising the membrane distillation module as defined in claim 1.

10. The wastewater treatment apparatus according to claim 9, wherein a wastewater circulative pipe is coupled to a wastewater flow path of said membrane distillation module, and a wastewater tank, a circulative pump and a heater are inserted in the wastewater circulative pipe, and a cooling water circulative pipe is coupled to a treated liquid flow path of said membrane distillation module, and a cooling water tank, a circulative pump, and a cooler are inserted in the cooling water circulative pipe.
